(19) United States
(12) Patent Application Publication
(10) Pub. No.: US 2022/0320562 A1
(43) Pub. Date: Oct. 6, 2022

(54) DEVICE FOR CREATING A STACK OF FUEL-CELL PLATES

(71) Applicant: SYMBIO, Vénissieux (FR)

(72) Inventor: Yannick GODARD, Blussans (FR)

(21) Appl. No.: 17/597,068

(22) PCT Filed: Jun. 24, 2020
(86) PCT No.: PCT/FR2020/051104

§ 371 Date: Dec. 23, 2021

(30) Foreign Application Priority Data
Jun. 25, 2019 (FR) FR1906856

(51) Int. Cl. H01M 8/2404; H01M 8/00

(52) U.S. Cl. CPC H01M 8/2404; H01M 8/006

(57) ABSTRACT

Device for creating a stack of plates, comprising tooling and at least one plate, the tooling comprising a base bearing at least one parallel rectilinear rod, these being distant one from the next by at least one inter-axis distance and having a first substantially circular section (S1), and the at least one plate being superposable and comprising at least as many holes (7) as there are rods (6), these being distant by the same at least one inter-axis distance, having a second substantially circular section (S2) able to contain the first section (S1), wherein the first section (S1) and the second section (S2) can turn relative to one another reciprocally between a first orientation (#1) in which the first section (S1) and the second section (S2) are an exact fit and a second orientation in which the first section (S1) and the second section (S2) are a free fit.

### TECHNICAL FIELD

The invention concerns the field of plate stacking and assembly. It finds particular application in the manufacture of fuel cells.

### Prior Art

A hydrogen cell or fuel cell of«Proton Exchange Membrane Fuel Cell»type, or PEMFC, in known manner allows the production of electric power by performing a water synthesis chemical reaction by means of a membrane electrode assembly comprising an electrolyte surrounded by two layers of catalyst. Hydrogen H2 is supplied to an anode arranged on one side of the membrane. It decomposes via oxidation: 2 H₂→4 H⁺+4 e⁻, into two hydrogen protons H⁺ and two electrons e⁻. The two H⁺ protons migrate through the membrane electrode assembly as far as a cathode arranged on the other side of the membrane electrode assembly. Oxygen O₂ is supplied, advantageously in the form of air, to the cathode. If an electrical circuit is set up between the anode and the cathode, allowing circulation of the electrons e⁻, these reach the cathode where they allow reduction of oxygen O2 into two oxygen ions O₂⁻: O₂+4e⁻→2 O₂⁻. The hydrogen protons and oxygen ions combine at the cathode to form water: 4 H⁺+2 O₂⁻→2H₂O. This reaction is highly exothermal. Circulation of the e⁻ electrons creates electrical power.

It is known, to obtain a fuel cell, to superimpose an advantageously metallic anode, a membrane electrode assembly and an advantageously metallic cathode in the form of thin layers.

Since one cell individually only produces a low amount of electrical power, it is also known to superimpose several tens or hundreds of said cells in a stack. Each anode, respectively cathode, of a cell is therefore in electrical contact with the cathode, respectively anode, of the following and preceding cell respectively. The cells are connected in series. The electrical circuit therefore connects the first anode/cathode with the last cathode/anode of the stack.

An anode, respectively cathode, respectively membrane electrode assembly, is integrated in an anode plate, respectively a cathode plate, respectively a membrane plate. A plate comprises its element: anode, cathode or membrane electrode assembly, completed with assembly elements and channels allowing the feeding of reactive gases or the output of reaction products.

Therefore, all the plate types: anode, cathode, bipolar (described below) or membrane, are of similar shape or are at least superimposable for stacking. All the plates are pierced with at least one superimposed and opposite-facing lumen to form at least one channel conveying hydrogen to supply this gas to the anodes. All the plates are also pierced with at least one superimposed and opposite-facing lumen to form at least one channel conveying air to supply oxygen to the cathodes and to extract the water produced by the chemical reaction. All the plates are also pierced with at least one superimposed and opposite-facing lumen to form at least one channel in which there circulates a cooling fluid to evacuate the strong heat produced by the chemical reaction.

It is also known to pre-assemble back-to-back an anode plate and a cathode plate to obtain a bipolar plate. A cell can then be assembled by periodically stacking a bipolar plate and a membrane plate. If all the bipolar plates are arranged in the same direction, the periodic succession is effectively obtained: anode, membrane electrode assembly, cathode, anode, etc. . . . . Only the two ends of the stack differ in that they comprise a single end anode or cathode, and terminals allowing the fuel cell to be connected to the different flows of reactive gases and cooling fluid.

Such as illustrated in FIG. 1, a fuel cell P can be produced by stacking in order: a first terminal T1, an end anode plate EA, a plurality of membrane plates ME, a bipolar plate BI being inserted between every two successive membrane plates ME, an end cathode plate K and a second terminal T2.

As illustrated in FIG. 2, to store the plates 3 (EA, ME, BI, EK) when fabricating a stack 2, tooling 4 is conventionally used comprising a base 5 carrying at least two parallel rectilinear rods 6, distant one from the next by at least a centre distance e′ and having a first circular section S1. The plates 3 to be stacked are superimposable and comprise at least as many holes 7 as the tooling 4 comprises rods 6, distant by the same (e=e′) at least one centre distance e and having a second circular section S2 able to contain the first section S1. The second section S2 can be inserted in the first section S1. Therefore, by engaging the holes 7 of the plates 3 on the rods 6 it is possible to stack the superimposed plates 3 in final configuration: a stack 2. For the relative positioning of the stacked plates 3 to be sufficiently accurate, the respective sections S1 et S2 have an exact fit e.g. sliding fit.

The problem which then arises with prior art circular sections S1, S2 is the withdrawal of the assembly 2 of plates 3 when the plates 3 are numerous, possibly up to several hundred, this withdrawal becoming an issue on account of possible edge loading leading to risk of deformation of the plates 3 and/or rods 6.

### SUMMARY OF THE INVENTION

To solve this problem, the invention proposes modifying the tooling 4/plate 3 interface by modifying the respective sections S1, S2 of the rods 6 and plates 3 to offer two configurations: a working configuration in which the two sections S1, S2 ensure precise guiding relative to each other as in the prior art, but also a release configuration in which the two sections S1, S2 lie further distant providing greater freedom of movement.

For this purpose, the subject of the invention is a device for creating a stack of plates, comprising tooling and at least one plate, the tooling comprising a base bearing at least one parallel rectilinear rod, these being distant one from the next by at least one centre distance, and having a first substantially circular section, and said at least one plate being superimposable and comprising at least as many holes as rods, these being distant by the same at least one centre distance, having a substantially circular second section able to contain the first section, wherein the first section and the second section can rotate relative to one another reciprocally between a first orientation in which the first section and the second section are an exact fit, and a second orientation in which the first section and the second section are a free fit.

Characteristics or particular embodiments able to be used alone or in combination are:
the first section is a circle having a first radius comprising at least two cut-outs leaving the same number of protuberances to subsist of first radius, of given angular widths and angular distances, and the second section is a circle having a second radius substantially equal to the first radius comprising the same number of cut-outs having angular widths respectively at least equal to the angular widths of the protuberances of the first section, and having angular distances respectively equal to the angular distances of the protuberances of the first section;
the first radius is substantially equal to the second radius to within a tolerance ensuring an exact fit, preferably a sliding fit;
the first section comprises n protuberances of same angular width, angularly equidistant, and the angular distance between the second orientation and the first orientation is equal to ½n turn, n being an integer of between 2 and 10, preferably of 3 or 4;
all the first sections of the rods are identical and all the second sections of the holes are identical;
the device further comprises means for alternately and simultaneously actuating all the rods, through one same angle;
the rods are able to be oriented in a default working orientation in which the rods lie in the first orientation relative to the holes, to allow stacking of the plates on the rods, and are able to be selectively oriented in a release orientation in which the rods lie in the second orientation relative to the holes, to allow withdrawal of the stack of plates from the rods and out of the tooling.

In a second aspect, the invention concerns said tooling.

In a third aspect the invention concerns said plate.

In a fourth aspect, the invention concerns a method for creating a stack of plates by means of said device, comprising the following steps: configuration of the tooling in a default working orientation in which the rods lie in the first orientation relative to the holes, stacking plates on the rods, assembling plates to form the stack, configuring the tooling in a release orientation in which the rods lie in the second orientation relative to the holes, and withdrawing the stack of plates from the rods and out of the tooling.

### BRIEF DESCRIPTION OF THE DRAWINGS

The invention will be better understood on reading the following description given solely as an example and with reference to the appended Figures in which:

FIG. 1 already described, gives a perspective view of a fuel cell;

FIG. 2 gives a perspective view of tooling for plate stacking, in the prior art and in the invention;

FIG. 3 gives a cross-section of one embodiment of the sections S1, S2 in working orientation;

FIG. 4 gives a cross-section of the same sections S1, S2, in release orientation;

FIG. 5 gives a cross-section of a preferred embodiment of sections S1, S2 in working orientation;

FIG. 6 gives a cross-section of the same sections S1, S2, in release orientation;

FIG. 7 gives a perspective view of the same sections S1, S2, in working orientation.

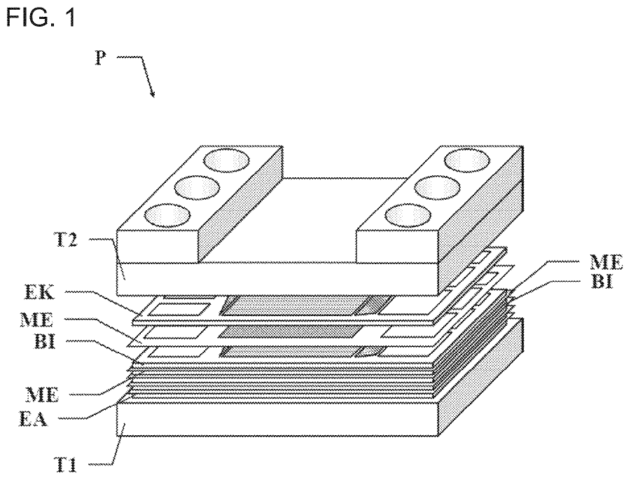

### DESCRIPTION OF EMBODIMENTS

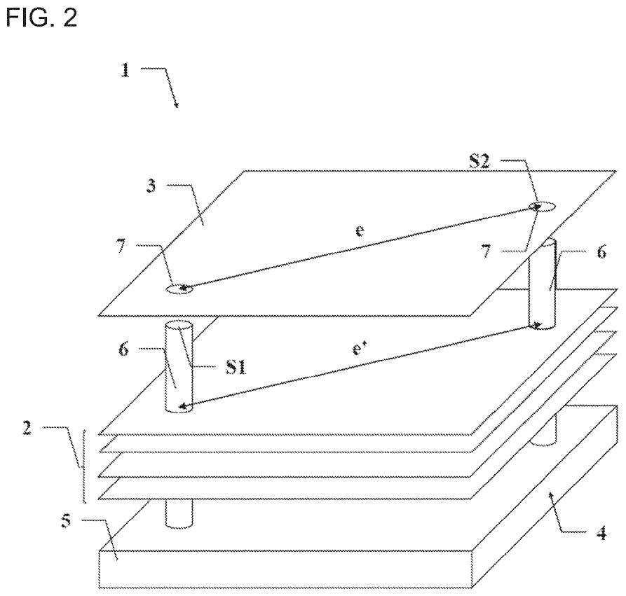

With reference to FIG. 2, a device 1 of the invention to create a stack 2 of plates 3 comprises tooling 4 and at least one plate 3. The tooling 4 comprising a base 5, advantageously planar, able to be arranged parallel to the advantageously planar plates 3 to be stacked. Said base 5 comprises plate positioning means able to impose the orientation of each plate in the plane thereof. The positioning means comprise at least one rod 6 able to be engaged in at least as many holes 7 pierced in the plates 3. The positioning means may also comprise at least one external abutment able to come into contact with a peripheral edge of the plates. Two rods 6 allow imposition of the orientation of the plates 3. A single rod 6 does not alone allow guaranteed orientation and is advantageously completed with at least one external abutment. A greater number of rods 6, preferably three or four, allows improved guiding of the plates 3 and/or the addition of at least one foolproofing. If the number of rods 6 is too high, the risks of static indeterminacy are increased. The rods 6 are rectilinear, advantageously perpendicular to the base 5. When applicable, if the number of rods 6 is at least two, the rods 6 are parallel to each other and distant one from the next by at least one centre distance e′. A centre distance e′ is defined between each pair of rods 6 taken two-by-two i.e. three centre distances for 3 rods 6, and six centre distances for four rods 6. A rod 6 has a first substantially circular section S1. A plate 3 is superimposable and comprises at least as many holes 7 as the tooling 4 comprises rods 6. There may be supernumerary holes 7. Said at least one hole 7 corresponding to rods 6 is arranged in a similar plane to the plane of said at least one rod 6 so that a plate 3 is able to be stacked by engaging the at least one hole 7 thereof on a rod 6, each hole on a rod. When applicable, if the number of holes 7 is at least two, they lie distant one from the next by centre distances e respectively equal to the corresponding centre distances e′. A hole 7 has a substantially circular second cross-section S2 able to contain the corresponding first cross-section S1, to allow engaging of a hole 7 on a rod 6.

According to one advantageous characteristic of the invention, the first cross-section S1 and the second section S2 can alternately rotate in relation to each other. With this rotation it is possible to change over from a working configuration characterized by a first relative orientation α1 of section S1 in relation to section S2, to a release configuration characterized by a second relative orientation α2 of section S1 in relation to S2 and reciprocally. In the first orientation α1, the first section S1 and the second section S2 are such that at least partially the respective circumference thereof is in contact to obtain an exact fit between a rod 6 and a hole 7. On the contrary, in the second orientation α2, the first section S1 and the second section S2 are such that no portion of their respective circumference is in contact, leaving sufficient space between them to obtain a free fit between a rod 6 and a hole 7.

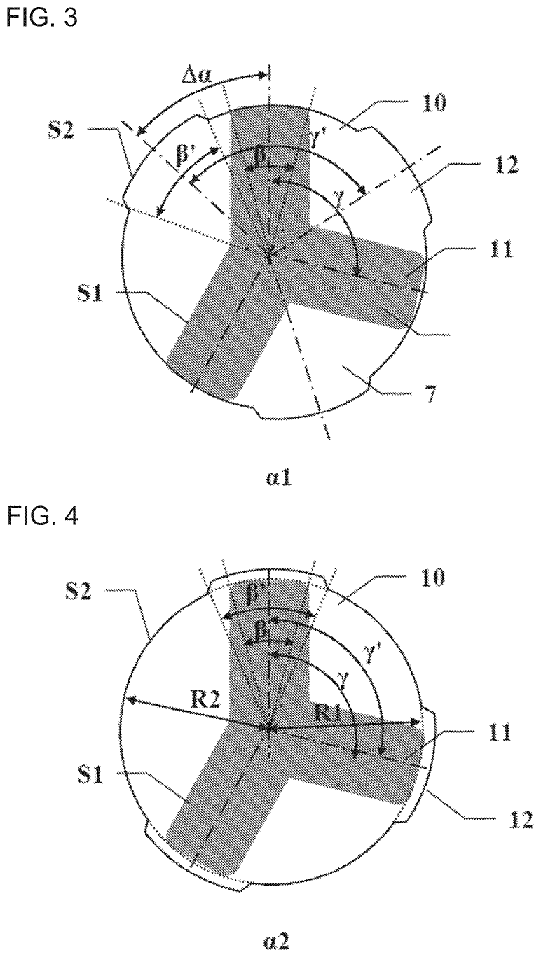

One example of relative conformation of sections S1, S2 allowing this characteristic to be obtained is more particularly illustrated in FIGS. 3 and 4.

The first section S1 of a rod 6 is constructed from a circle of first radius R1 in which there are made at least two cut-outs 10. These at least two cut-outs 10 form as many protuberances 11 having said first radius R1. Each protuberance 11 has an angular width β or occupied angular sector β particular thereto. Each pair of protuberances 11 is also characterized by an angular distance γ measured between the axes of said two protuberances 11. There are therefore as many angular widths β and as many angular distances γ as protuberances 11. Section S1 has a radius R1 perpendicular to each protuberance 11 over its angular width β, and a radius smaller than radius R1 perpendicular to each cut-out 10 existing between two protuberances 11. Here, a cut-out 10 removes material from a solid rod 6 thereby decreasing radius R1.

The second section S2 of a hole 7 is constructed from a circle of second radius R2, substantially equal to the first radius R1, in which as many cut-outs 12 are made as there are cut-outs 10 made in the first section S1, or this being equivalent to as many protuberances 11 as there are in the first section S1. The cut-outs 12 of the second section S2 are angularly separated one from the next by angular distances γ′ respectively taken to be equal to the angular distances γ of the protuberances 11 in the first section S1.

Therefore, such as illustrated in FIG. 4 showing a relative release orientation α2, a protuberance 11 of the first section S1 lies opposite a cut-out 12 of the second section S1 and reciprocally.

In addition, each respective cut-out 12 of the second section S2 has an angular width β′ at least equal to the angular width β of the corresponding (facing) protuberance 11 of the first section S1. Each angular width β′ is preferably greater than the corresponding angular width β. Therefore, as illustrated in FIG. 4, a comfortable space is provided between the first section S1 and second section S2 in orientation α2, allowing any contact to be prevented and hence any edge loading when withdrawing the stack 2 of plates 3. Here a cut-out removes material from a hollow hole 7 and thereby increases the second radius R2.

On the contrary, as illustrated in FIG. 3, in working orientation α1 the protuberances 11 of the first section S1, having a first radius R1, lie facing a portion of the second section S2 that does not have a cut-out and having a second radius R2 substantially equal to the first radius R1, and hence substantially in contact.

The reciprocal changeover from orientation α1 to orientation α2 is obtained by relative rotation through an angle+/−Δa. Bearing in mind that it is difficult to rotate a hole 7 since it is included in the plate 3, this relative rotation is advantageously applied to the rods 6 which then rotate about their axis.

It was seen above that the first radius R1 is substantially equal to the second radius R2. Substantially equal is to be understood herein as having tolerance allowing an exact fit to be obtained. By exact fit it is meant herein as a function of desired precision of stacking, to allow the positioning of plates 3 on the rods 6. By way of illustration, an exact fit can be a sliding fit.

It follows from FIGS. 3 and 4 that the angular distances γ can be any distances. However, the corresponding angular distances γ′ are to be adapted between the first section S1 and the second section S2. Similarly, the angular width β of a protuberance 11 can be independent of the angular width of another protuberance 11, provided this angular width β corresponds to the angular width β′ pf the opposite-facing cut-out 12.

According to another characteristic, the first section S1 and the second section S2 have regular star-shaped profiles. Therefore, the first section S1 comprises n angularly equidistant protuberances 11 with n being an integer. It evidently follows that the second section S2 comprises as many i.e. n angularly equidistant cut-outs 12. Advantageously, the n protuberances 11 have one same angular width β. As a result, the n cut-outs 12 of the second section S2, have one same equal or advantageously greater width angular width β′. It can be inferred therefrom that the angular distance Δa between the second orientation α2 and the first orientation α1, Δα=α2-α1, is equal to ½n turn.

The number n of branches of the star is at least two; n cannot be made too high as there is a risk of excessive reduction of the rotation angle Δa between the working configuration and the release configuration. Therefore, n=10 appears to be a maximum value. The case in which n=2 branches can be the subject of jamming in rotation. Therefore, n is preferably 3 or 4.

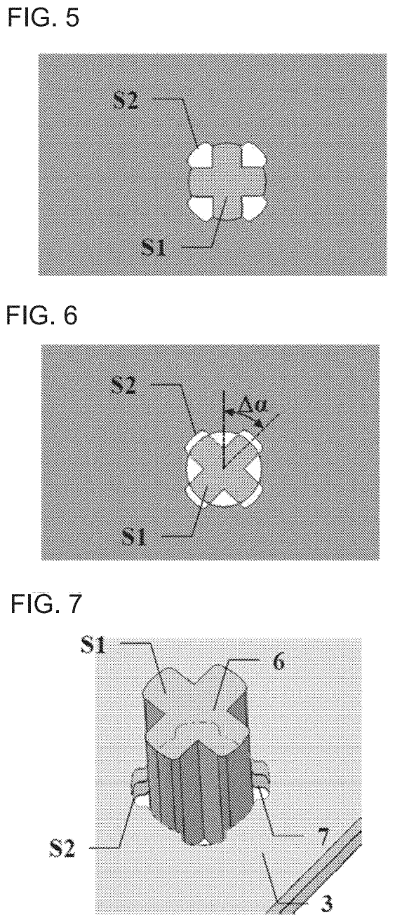

FIGS. 5-7 illustrates said embodiment with n=4. An angle of rotation Da of ⅛ turn can be seen, or 45°.

Each rod 6/hole 7 pair can independently have its own pair of sections S1, S2. Also, the relative angles between the first section S1 and second section S2 of said pair must be heeded, but it is not necessary for two rods 6 to be relatively oriented.

According to another characteristic, all the first sections S1 of the rods 6 are identical with each other and all the second sections S2 of the holes 7 are identical with each other.

According to another characteristic, the device 1 advantageously and more particularly the tooling 4, further comprises means (not illustrated) to actuate all the rods 6 alternately and simultaneously through one same angle Δa. With said actuating means, it is advantageously possible to cause all the rods 6 to be changed over simultaneously from a working configuration α1 to a release configuration α2 and vice versa in a single manoeuvre.

According to another characteristic, the device 1 orients the rods 6 by default in a working orientation, the rods 6 lying in the first orientation α1 in relation to the holes 7. This can be obtained with return means of the rods 6 or the actuation means. The working orientation allows stacking of the plates 3 on the rods 6. The rods 6 can also be selectively oriented, for example using the actuation means, in a release orientation in which the rods 6 lie in the second orientation α2 in relation to the holes 7. This allows the stack 2 of plates 3 to be withdrawn from the rods and hence out of the tooling 4.

The invention also concerns tooling 4 conformed so that it is able to be used in said device 1.

The invention also concerns a plate 3 conformed so that it is able to be used in said device 1.

The invention further concerns a method for creating a stack 2 of plates 3 by means of said device 1, comprising the following steps. Initially, the tooling 4 is configured in working orientation, advantageously by default, so that the rods 6 lie in the first orientation α1 in relation to the holes 7. It is then possible to proceed with stacking plates 3 on the rods 6 in sufficient number to obtain a stack 2. The plates 3 thus stacked undergo all the operations allowing a stack 2 to be obtained: assembling, sealing, etc. The tooling 4 is then configured in release orientation in which the rods 6 lie in the second orientation α2 in relation to the holes 7. This allows limited contact between rods 6 and holes 7, thereby allowing easy withdrawal of the stack 2 of plates 3 from the rods 4 and hence out of the tooling 4.

The present invention is advantageously applied to the manufacture of a fuel cell.

The invention has been illustrated and described in detail in the drawings and foregoing description. This description is to be construed as illustrative, given as an example and not as limiting the invention to this description alone. Numerous variants of embodiment are possible.

### LIST OF REFERENCE NUMBERS

1: device,
2: stack,
3: plate,
4: tooling,
5: base,
6: rod,
7: hole,
10: cut-out,
11: protuberance,
12: cut-out,
e, e′: centre distance,
S1: rod section,
S2: hole section,
α1: exact fit orientation,
α2: free fit orientation,
Δa: α2-α1,
R1: radius of S1,
R2: radius S2,
β, β′: angular width of S1, S2,
Γ, γ′: angular distance of S1, S2,
n: number of protuberances.

1-10. (canceled)

11. A device for creating a stack of plates, comprising a tooling and at least one plate, the tooling comprising a base bearing at least one parallel, rectilinear rod, the rods being distant one from the next by at least one centre distance and having a first circular section, and said at least one plate being superposable and comprising at least as many holes as there are rods, the holes being distant by the same at least one centre distance, and having a second circular section able to contain the first section, wherein the first section and the second section can rotate relative to one another reciprocally between a first orientation in which the first section and second section are in exact fit and a second orientation in which the first section and the second section are a free fit.

12. The device according to claim 11, wherein the first section is a circle having a first radius comprising at least two cut-outs leaving as many protuberances to subsist of first radius, of given angular widths and angular distances, and the second section is a circle having a second radius, equal to the first radius, comprising as many cut-outs respectively of angular widths at least equal to the angular widths of the protuberances of the first section and having angular distances respectively equal to the angular distances of the protuberances of the first section.

13. The device according to claim 12, wherein the first radius is equal to the second radius within a tolerance ensuring an exact fit.

14. The device according to claim 13, wherein the fit is a sliding fit.

15. The device according to claim 12 wherein the first section comprises n protuberances of same angular width, angularly equidistant, and wherein the angular distance between the second orientation and the first orientation is equal to ½n turn, n being an integer of between 2 and 10.

16. The device according to claim 15, wherein n is 3 or 4.

17. The device according to claim 11, wherein all the first sections of the rods are identical and all the second sections of the holes are identical.

18. The device according to claim 11, further comprising means for actuating all the rods alternately and simultaneously, through one same angle.

19. The device according to claim 11, wherein the rods are able to be oriented in a default working orientation in which the rods lie in orientation relative to the holes, to allow stacking of the plates on the rods, and are able to be selectively oriented in a release orientation in which the rods lie in the second orientation relative to the holes, to allow withdrawal of the stack of plates from the rods and out of the tooling.

20. A tooling able to be used in a device according to claim 11.

21. A plate able to be used in a device according to claim 11.

22. A method for creating a stack of plates by means of a device according to claim 11, comprising the following steps: configuring the tooling in default working orientation in which the rods lie in a first orientation relative to the holes, stacking plates on the rods, assembling plates to form the stack, configuring the tooling in release orientation in which the rods lie in a second orientation relative to the holes, and withdrawing the stack of plates from the rods and out of the tooling.
